(19) United States
(12) Patent Application Publication
(10) Pub. No.: US 2013/0279824 A1
(43) Pub. Date: Oct. 24, 2013

(54) MEDIAN FILTERING APPARATUS AND METHOD

(71) Applicant: FUJITSU LIMITED, (US)

(72) Inventor: JianQing ZHU, Kawasaki (JP)

(73) Assignee: FUJITSU LIMITED, Kawasaki (JP)

(21) Appl. No.: 13/796,257

(22) Filed: Mar. 12, 2013

(30) Foreign Application Priority Data
Mar. 14, 2012 (CN) 201210072448.5

(51) Int. Cl. G06T 5/00

(52) U.S. Cl. CPC G06T 5/002
USPC 382/262

(57) ABSTRACT

A median filtering apparatus and related method for finding out a median from 2r+1 input data, which includes 2(r+1) comparators, a counter, a circuit to obtain a minimum, a register, a state machine, and an adder. 2r+1 comparators of the comparators compare input data with a first predetermined value and compare the 2r+1 input data with an output value of the register. The counter counts the number of input data that are not larger than the first predetermined value or the output value of the register of the input data. The circuit finds out a minimum value of the input data that are larger than the first predetermined value or the output value of the register of the input data and a second predetermined value. The remaining one comparator of the 2(r+1) comparators compares the number counted by the counter with “r”.

### FIELD OF THE INVENTION

The invention relates to image processing, and in particular to a median filtering apparatus and method used in an image processing system.

### BACKGROUND

Median filtering is an order-statistic-theory-based nonlinear signal processing technique that can effectively suppress noises, wherein the basic principle of median filtering is to replace the value at a point in a digital image or a digital sequence with a median of values at respective points within a neighborhood of the point, to make the value at the point close to its reality value so as to eliminate an isolated noise. Since median filtering has a characteristic of eliminating noises in an image while maintaining details of the image, it is widely used in image processing.

An expression of median filtering is g=median (f0, f2, . . . f2r). That is, 2r+1 input data are ordered based on a small-to-big order, and then a value that is ordered in a middle position is output (i.e., g is a value at the r^{th} position). For example, median (0, 4, 3, 5, 3, 6, 2, 9, 1)=3.

Generally, a large amount of hardwares are required when implementing median filtering by hardwares. For example, in a nine-point (n bits for each point) median filter shown in FIG. 1, 25 comparators and 18 n-bit flip-flops are required. A specific circuit diagram of the comparator shown in FIG. 1 is shown in FIG. 2. Although the US patent application US2003/0095718A1 proposes a median filter realized by fewer hardwares as shown in FIG. 3, it still requires 17 comparators and 16 n-bit flip-flops.

### SUMMARY OF THE INVENTION

In view of the problems stated above, the invention provides a novel median filtering apparatus and method.

A median filtering apparatus in accordance with an embodiment of the invention is used for finding out a median from 2r+1 input data, the apparatus comprising 2(r+1) comparators, a counter, a circuit for obtaining a minimum, a register, a state machine, and an adder, wherein 2r+1 comparators of the 2(r+1) comparators are used for comparing the 2r+1 input data with a first predetermined value and for comparing the 2r+1 input data with an output value of the register; the counter is used for counting the number of input data that are not larger than the first predetermined value or the output value of the register of the 2r+1 input data; the circuit for obtaining a minimum is used for finding out a minimum of the input data that are larger than the first predetermined value or the output value of the register of the 2r+1 input data and a second predetermined value; the register is used for registering the minimum found out by the circuit for obtaining a minimum; the remaining one comparator of the 2(r+1) comparators is used to comparing the number counted by the counter with “r”; and the state machine and the adder are used for generating an indication signal indicating whether the output value of the register is the median of the 2r+1 input data in accordance with the comparing result of the remaining one comparator and a trigger signal from external.

A median filtering method in accordance with an embodiment of the invention is used for finding out a median of 2r+1 input data f(0) to f(2r), the method comprising: finding out the 0^{th} to the r^{th} minimum values of the 2r+1 input data f(0) to f(2r) in turn in multiple clock cycles, wherein only one minimum value is found out in each clock cycle; taking the r^{th} minimum value as the median of the input data f(0) to f(2r), wherein the processing of finding out the 0^{th} to the r^{th} minimum values of the 2r+1 input data f(0) to f(2r) comprises: comparing the input data f(0) to f(2r) with a first predetermined value, respectively; taking k input data that are not larger than the first predetermined value of the input data f(0) to f(2r) as the 0^{th} to the k^{th} minimum values of the input data f(0) to f(2r), and taking m minimum values of “M” of the input data that are larger than the first predetermined value in the input data f(0) to f(2r) as the (k+1)^{th} to the (k+m)^{th} minimum values of the input data f(0) to f(2r); comparing the input data f(0) to f(2r) with the minimum value of “M”, respectively; taking n minimum values of “N” of the input data that are larger than the minimum value of “M” of the input data f(0) to f(2r) as the (k+m+1)^{th} to the (k+m+n)^{th} minimum values of the input data f(0) to f(2r); repeating the processing of comparing and obtaining a minimum value by taking the minimum value found out in a previous step as a comparing value for a next step until the r^{th} minimum value of the input f(0) to f(2r) are found out.

Compared with traditional median filtering methods and apparatuses, the invention includes fewer circuits. If there is a plurality of data with a same value in the input data, the median filtering method and apparatus of the invention have a higher seeking speed.

### DESCRIPTION OF THE DRAWINGS

The invention can be better understood through the following description in conjunction with the accompanying drawings, wherein:

FIG. 1 illustrates a hardware configuration diagram of a traditional median filtering apparatus;

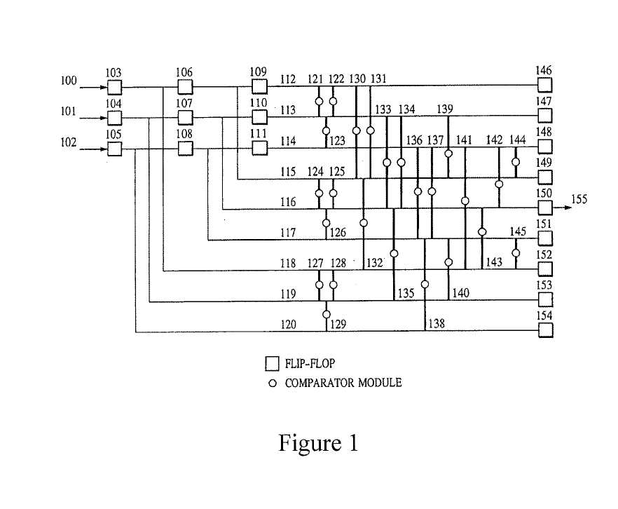

FIG. 2 illustrates a specific circuit diagram of a comparator shown in FIG. 1;

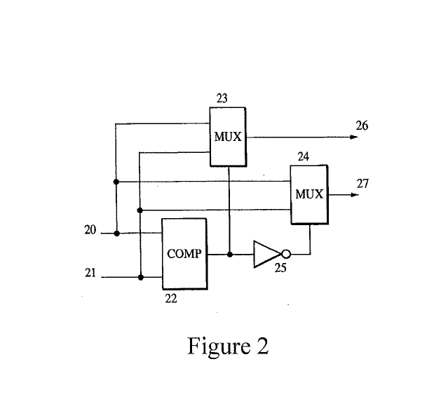

FIG. 3 illustrates a hardware configuration diagram of another traditional median filtering apparatus;

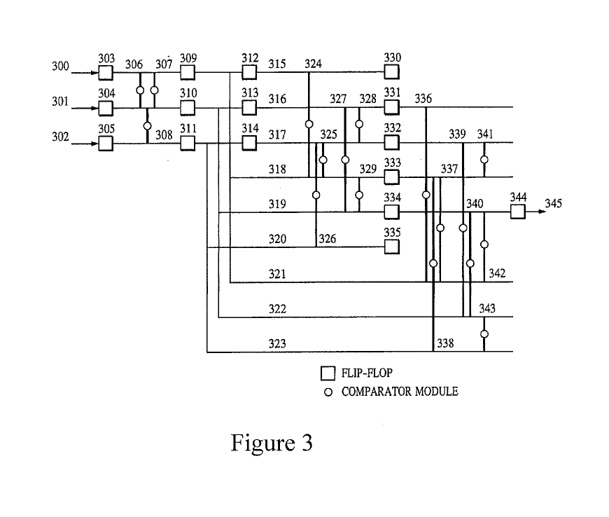

FIG. 4 illustrates a hardware configuration diagram of the median filtering apparatus in accordance with an embodiment of the invention;

FIG. 5 illustrates a flow chart of a median filtering method in accordance with an embodiment of the invention; and

FIG. 6 illustrate a circuit for obtaining a minimum value among 9 values in a median filtering apparatus for finding out a median among 9 input data in accordance with an embodiment of the invention.

### DETAILED EMBODIMENTS

Next, characteristics and exemplary embodiments of various aspects of the invention will be described in detail. The following description covers many specific details so as to provide comprehensive understanding of the invention.

However, it would be obvious for those skilled in the art that the invention may be implemented in absence of some of the specific details. The following descriptions of embodiments are merely for providing clearer understanding of the invention through illustrating examples of the invention. The invention is not limited to any specific configuration and algorithm provided below; instead, it covers any modification, substitution, and improvement of corresponding elements, components and algorithms without departing from the spirit of the invention.

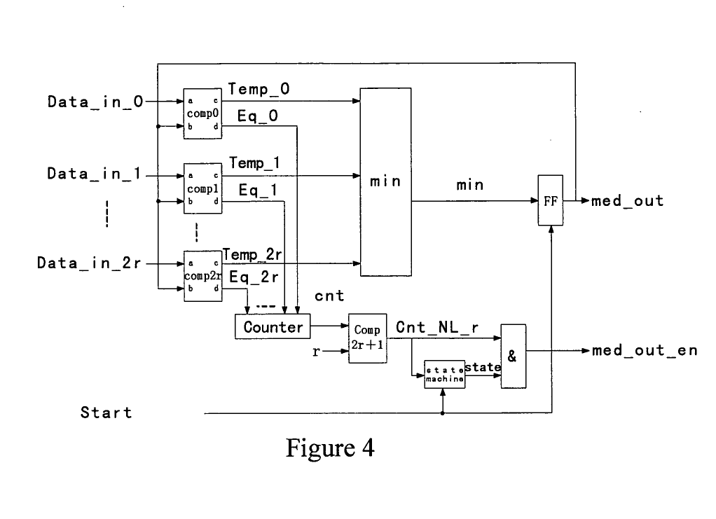

FIG. 4 illustrates a median filtering apparatus for finding out a median from 2r+1 input data in accordance with an embodiment of the invention. In the median filtering apparatus shown in FIG. 4, 2(r+1) comparators, a counter, a circuit for obtaining a minimum, a register, a state machine, an adder, and a flip-flop (the flip-flop is not shown and is optional) are comprised.

During a clock cycle, the circuit for obtaining a minimum outputs a minimum value. If the minimum value is not the r^{th} minimum value among 2r+1 input data, the minimum value is stored in the register and then is compared with the 2r+1 input data as a comparing reference so as to implement a next round of minimum obtaining and storing process. The above process is repeated until the r^{th} minimum value (i.e. the median) among the 2r+1 input data is found out.

It should be noted that during a first clock cycle, 2r+1 input data are compared with a predetermined value (i.e., the minimum value that can be taken by the 2r+1 input data). For example, in the case that all of the 2r+1 input data are n-bit data, the predetermined value is the minimum that can be taken by them, i.e., 0.

The comparator “0” to the comparator “2r” used in FIG. 4 are the same kind of comparators. Input terminals of such a comparator are “a” and “b”, and output terminals of the comparator are “c” and “d”, and the logic relation between the input terminals and the output terminals is the following:

if a<b, then c=MAX_NUM, d=1;

or else c=a, d=0.

Wherein MAX_NUM is the maximum value that can be taken by the 2r+1 input data. For example, in the case that all of the 2r+1 input data are n-bit data, the maximum value that can be taken by them is MAX_NUM=2ⁿ−1.

The counter shown in FIG. 4 is used for counting the number of “1” among Eq_{—}0 to Eq_{—}2r (i.e., counting the number of counters with d=1 among the comparator “1” to the comparator “2r”). The comparator “2r+1” shown in FIG. 4 is used for comparing the output “cnt” of the counter with a digital value “r”, and obtaining a result signal Cnt_NL_r. Wherein if “cnt” is not less than “r” (i.e., cnt≧r), then Cnt_NL_r=1; and if “cnt” is less than r (i.e., cnt<r), then Cnt_NL_r=0.

The state machine shown in FIG. 4 is a 1-bit state machine. If a “start” signal triggered by the flip-flop is true, then the state machine outputs a signal “state=1”, indicating that the whole median filtering apparatus is in operation; if Cnt_NL_r=1 and “state=0”, it indicates that the current operation of the median filtering apparatus ends, i.e., the median of the 2r+1 input data is obtained.

An output signal “med out en” of the adder shown in FIG. 4 indicates effectiveness of “med_out”. When med_out_en=1, it indicates that “med_out” is an effective median; and when med_out_en=0, it indicates that “med_out” is not a median.

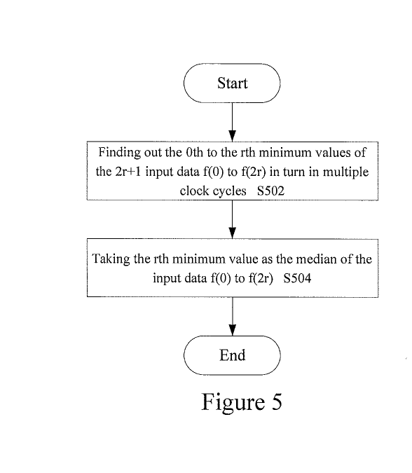

As can be seen from the aforementioned descriptions in conjunction with FIG. 4, the median filtering apparatus in accordance with an embodiment of the invention implements a median filtering method for finding out a median of 2r+1 input data f(0) to f(2r). FIG. 5 illustrates a flow chart of a median filtering method in accordance with an embodiment of the invention. As shown in FIG. 5, the median filtering method comprises: S502, finding out the 0^{th} to the r^{th} minimum values of the 2r+1 input data f(0) to f(2r) in turn in multiple clock cycles, wherein only one minimum value is found out in each clock cycle; S504, taking the r^{th} minimum value as the median of the input data f(0) to f(2r).

Specifically, the process of finding out the 0^{th} to the r^{th} minimum values of the 2r+1 input data f(0) to f(2r) comprises: comparing the input data f(0) to f(2r) with a predetermined value “A”, respectively; taking k input data that are equal to or less than the predetermined value “A” of the input data f(0) to f(2r) as the 0^{th} to the k^{th} minimum values of the input data f(0) to f(2r), and taking m minimum values of “B” of the input data that are larger than the predetermined value “A” in the input data f(0) to f(2r) as the (k+1)^{th} to the (k+m)^{th} minimum values of the input data f(0) to f(2r); comparing the input data f(0) to f(2r) with the minimum value of “B”, respectively; taking n minimum values of “C” of the input data that are larger than the minimum value of “B” of the input data f(0) to f(2r) as the (k+m+1)^{th} to the (k+m+n)^{th} minimum values of the input data f(0) to f(2r); repeating the processing of comparing and obtaining a minimum value by taking the minimum value found out in a previous step as a comparing value for a next step until the r^{th} minimum value of the input f(0) to f(2r) is found out, wherein the predetermined value “A” is the minimum value that can be taken by the input data f(0) to f(2r).

Next, a working flow of the median filtering apparatus in accordance with an embodiment of the invention will be further described with reference to an example. It is assumed that a median of 9 input data [0, 1, 7, 4, 3, 4, 8, 9, 6] is required to be found out (under this condition, 10 comparators are required, and comparators “0” to “8” correspond to comparators “0” to “2r”, and a comparator “9” corresponds to the comparator “2r+1”).

In the median filtering apparatus shown in FIG. 4, [Data_in0˜Data_in8]=[0, 1, 7, 4, 3, 4, 8, 9, 6]. The first clock cycle right after the “start” signal arrives is denoted as “0”, the next cycle is denoted as “1”, and so on.

In the clock cycle “0”, the output “med_out” of the register is reset to 0, and the output of the state machine is “state=1”;

outputs “c” of the register “0” to the register “8” are the following: [Temp_{—}0˜Temp_{—}8]=[MAX_NUM, 1, 7, 4, 3, 4, 8, 9, 6];

outputs “d” of the register “0” to the register “8” are the following: [Eq_{—}0 Eq_{—}8]=[1, 0, 0, 0, 0, 0, 0, 0, 0];

the output of the counter is “cnt=1”, and the output of the comparator “9” is “Cnt_NL_r=0”;

the output of the adder is “med_out_en=0”; and

the output of the circuit for obtaining a minimum is “min=1”.

In the clock cycle “1”, the output of the register is “med_out=1”, and the output of the state machine is “state=1”;

outputs “c” of the register “0” to the register “8” are the following: [Temp_{—}0˜Temp_{—}8]=[MAX_NUM, MAX_NUM, 7, 4, 3, 4, 8, 9, 6];

outputs “d” of the register “0” to the register “8” are the following: [Eq_{—}0˜Eq_{—}8]=[1, 1, 0, 0, 0, 0, 0, 0, 0];

the output of the counter is “cnt=2”, and the output of the comparator “9” is “Cnt_NL_r=0”;

the output of the adder is “med_out_en=0”; and

the output of the circuit for obtaining a minimum is “min=3”.

In the clock cycle “2”, the output of the register is “med_out=3”, and the output of the state machine is “state=1”;

outputs “c” of the register “0” to the register “8” are the following: [Temp_{—}0˜Temp_{—}8]=[MAX_NUM, MAX_NUM, 7, 4, MAX_NUM, 4, 8, 9, 6];

outputs “d” of the register “0” to the register “8” are the following: [Eq_{—}0 ˜Eq_{—}8]=[1, 1, 0, 0, 1, 0, 0, 0, 0];

the output of the counter is “cnt=3”, and the output of the comparator “9” is “Cnt_NL_r=0”;

the output of the adder is “med_out_en=0”; and

the output of the circuit for obtaining a minimum is “min=4”.

In the clock cycle 3, the output of the register is “med_out=4”, and the output of the state machine is “state=1”;

outputs “c” of the register “0” to the register “8” are the following: [Temp_{—}0˜Temp_{—}8]=[MAX_NUM, MAX_NUM, 7, MAX_NUM, MAX_NUM, MAX_NUM, 8, 9, 6];

outputs “d” of the register “0” to the register “8” are the following: [Eq_{—}0˜Eq_{—}8]=[1, 1, 0, 1, 1, 1, 0, 0, 0];

the output of the counter is “cnt=5”, and the output of the comparator “9” is “Cnt_NL_r=1”;

the output of the adder is “med_out_en=1”; and

the output of the circuit for obtaining a minimum is “min=6”.

Then, the median of “4” is output.

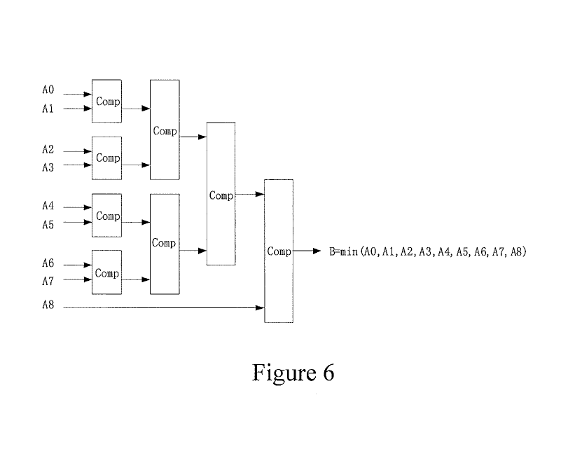

FIG. 6 illustrates a circuit for obtaining a minimum value among 9 values in a median filtering apparatus for finding out a median among 9 input data in accordance with an embodiment of the invention (as shown in FIG. 6, 8 comparators are required).

By an extension of this logic, the circuit for obtaining a median shown in FIG. 4 can comprise 2r comparators (in other words, it may be composed of 2r comparators).

As can be seen, in the embodiment of the invention, the median filtering apparatus for finding out a median of 9 input data (n bits for each data) requires 18 comparators and 1 n-bit flip-flop (for triggering a “start” signal, not shown in the figures), which are less than circuits necessary for existing median filtering apparatuses. If multiple minimum values are searched at one time, the counter would count the number of the minimum values at one time, so that seeking speed is massively accelerated.

Compared with traditional median filtering methods and apparatus, the invention has fewer circuits. If there is a plurality of data with a same value in the input data, the median filtering method and apparatus of the invention have a higher seeking speed.

Although the invention has been described with reference to detailed embodiments of the invention, those skilled in the art would understand that modifications, combinations and changes may be done to the specific embodiments without departing from the scope and spirit of the invention as defined by the appended claims and the equivalents thereof

Hardware or software may be used to perform the steps as required. It should be noted that under the premise of not departing from the scope of the invention, the steps may be amended, added to or removed from the flow chart provided by the description. Generally, a flow chart is only one possible sequence of basic operations performing functions.

Embodiments of the invention may be implemented using a general programmable digital computer, a specific integrated circuit, programmable logic devices, a field-programmable gate array, and optical, chemical, biological, quantum or nano-engineering systems, components and institutions. Generally, functions of the invention may be realized by any means known to those skilled in the art. Distributed or networked systems, components and circuits may be used. And data may be transmitted wired, wirelessly, or by any other means. It shall be realized that one or more elements illustrated in the accompanying drawings may be realized in a more separated or more integrated method; they would even be allowed to be removed or disabled under some conditions. Realizing programs or codes capable of being stored in machine readable media so as to enable a computer to perform the aforementioned method also fails within spirit and scope of the invention.

Additionally, any arrows in the accompanying drawings shall be regarded as being exemplary rather than limiting. And unless otherwise indicated in detail, combinations of components and steps shall be regarded as being recorded when terms are foreseen as leading unclearness to the ability for separating or combining.

What is claimed is:

1. A median filtering apparatus for finding out a median from 2r+1 input data, characterizing comprising 2(r+1) comparators, a counter, a circuit for obtaining a minimum, a register, a state machine, and an adder, wherein:
2r+1 comparators of the 2(r+1) comparators are used for comparing the 2r+1 input data with a first predetermined value and for comparing the 2r+1 input data with an output value of the register;
the counter is used for counting the number of input data that are not larger than the first predetermined value or the output value of the register of the 2r+1 input data;
the circuit for obtaining a minimum is used for finding out a minimum of the input data that are larger than the first predetermined value or the output value of the register of the 2r+1 input data and a second predetermined value;
the register is used for registering the minimum found out by the circuit for obtaining a minimum;
the remaining one comparator of the 2(r+1) comparators is used to comparing the number counted by the counter with “r”; and
the state machine and the adder are used for generating an indication signal indicating whether the output value of the register is the median of the 2r+1 input data in accordance with the comparing result of the remaining one comparator and a trigger signal from external.

2. The median filtering apparatus of claim 1, characterized in that the 2r+1 comparators are of the same type, wherein the comparator has two input terminals “a” and “b”, and two output terminals “c” and “d”, and the logic relation between the input terminals “a” and “b” and the output terminals “c” and “d” is the following: if a≦b, then c=the second predetermined value, d=1; or else c=a, d=0.

3. The median filtering apparatus of claim 1, characterized in that the remaining one comparator has two input terminals and one output terminal, wherein if the input of the first one of the two input terminals is not less than the input of the second one of the two input terminals, the output value of the one output terminal is 1, or else the output value of the one output terminal is 0.

4. The median filtering apparatus of claim 1, characterized in that the first predetermined value is the minimum that can be taken by the 2r+1 input data.

5. The median filtering apparatus of claim 1, characterized in that the second predetermined value is the maximum that can be taken by the 2r+1 input data.

6. The median filtering apparatus of claim 1, characterized in that the circuit for obtaining a minimum includes 2r comparators.

7. A median filtering method for finding out a median of 2r+1 input data f(0) to f(2r), the method comprising:
finding out the 0^{th} to the r^{th} minimum values of the 2r+1 input data f(0) to f(2r) in turn in multiple clock cycles, wherein only one minimum value is found out in each clock cycle;
taking the r^{th} minimum value as the median of the input data f(0) to f(2r), wherein
the processing of finding out the 0^{th} to the r^{th} minimum values of the 2r+1 input data f(0) to f(2r) comprises:
comparing the input data f(0) to f(2r) with a first predetermined value, respectively;
taking k input data that are not larger than the first predetermined value of the input data f(0) to f(2r) as the 0^{th} to the k^{th} minimum values of the input data f(0) to f(2r), and taking m minimum values of “M” of the input data that are larger than the first predetermined value in the input data f(0) to f(2r) as the (k+1)^{th} to the (k+m)^{th} minimum values of the input data f(0) to f(2r);
comparing the input data f(0) to f(2r) with the minimum value of “M”, respectively;
taking n minimum values of “N” of the input data that are larger than the minimum value of “M” of the input data f(0) to f(2r) as the (k+m+1)^{th} to the (k+m+n)^{th} minimum values of the input data f(0) to f(2r);
repeating the processing of comparing and obtaining a minimum value by taking the minimum value found out in a previous step as a comparing value for a next step until the r^{th} minimum value of the input f(0) to f(2r) are found out.

8. The median filtering method of claim 7, characterized in that the first predetermined value is the minimum that can be taken by the 2r+1 input data.
